(19) United States
(12) Patent Application Publication
(10) Pub. No.: US 2023/0199479 A1
(43) Pub. Date: Jun. 22, 2023

(54) CAPABILITY COORDINATION BETWEEN WIRELESS DEVICES

(71) Applicant: ZTE CORPORATION, Shenzhen (CN)

(72) Inventors: Wenting LI, Shenzhen (CN); He HUANG, Shenzhen (CN)

(73) Assignee: ZTE CORPORATION, Shenzhen (CN)

(21) Appl. No.: 18/112,611

(22) Filed: Feb. 22, 2023

Related U.S. Application Data
(63) Continuation of application No. PCT/CN2020/122742, filed on Oct. 22, 2020.

(51) Int. Cl. H04W 8/22; H04W 76/10; H04W 60/04

(52) U.S. Cl. CPC H04W 8/22; H04W 76/10; H04W 60/04

(57) ABSTRACT

For multi-subscriber identity module (multi-SIM) wireless devices, the wireless device may connect to multiple networks at the same time. This may need coordination of the wireless device capability (capability coordination). A wireless device that is roaming may connect to multiple networks using different slices which also may require capability coordination. Video, Imaging and Audio for Professional Applications (VIAPA) devices may require a wireless device to receive data services from one network (e.g., a non-public network (NPN)), and paging as well as data services from another network (e.g., a public land mobile network (PLMN) simultaneously which may also require wireless device capability coordination.

### TECHNICAL FIELD

This patent document is directed generally to wireless communications.

### BACKGROUND

Mobile communication technologies are moving the world toward an increasingly connected and networked society, The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, simultaneous connection to multiple networks, longer battery life, and improved performance are being discussed.

### SUMMARY

This patent document describes, among other things, techniques, and apparatuses for providing coordination of the capabilities of a wireless device with one or more networks.

In one aspect, a method of wireless communication is disclosed. The method includes determining, at a wireless device, one or more user equipment (UE) capability sets associated with the wireless device based on an operational condition, The method further includes transmitting, from the wireless device to a network node, the one or more UE capability sets in a message.

In another aspect, a method of wireless communication is disclosed. The method includes receiving, at a network node from a wireless device, one or more user equipment (UE) capability sets associated with the wireless device based on an operational condition. The method further includes receiving, at the network node form the wireless device, assistance information related to a selected UE capability set from the one or more UE capability sets. The method includes determining, at the network node, a final adopted UE capability to assign to the wireless device based on the selected UE capability and the one or more UE capability sets. The method further includes transmitting, by the network node, the final adopted UE capability to the wireless device.

These, and other, aspects are described in the present document.

### BRIEF DESCRIPTION OF DRAWINGS

FIG. 1 depicts a schematic comparison of a fill capability set to a reduced capability set.

FIG. 2 depicts an example of a process.

FIG. 3 depicts another example of a process.

FIG. 4 depicts an example of six band combination capability items.

FIG. 5 depicts an example of adopted band capabilities.

FIG. 6 shows an example of dividing a wireless device capability into four categories.

FIG. 7 shows another example or a process.

FIG. 8 depicts examples of a full capability set and multiple reduced capability sets.

FIGS. 9-11 shows other examples of processes.

FIG. 12 depicts an example of a wireless communication system where techniques in accordance with one or more embodiments of the present technology can be applied.

FIG. 13 depicts an example of a block diagram representing a portion of a wireless device or base station in accordance with one or more embodiments of the present technology can be applied.

### DETAILED DESCRIPTION

Certain features are described using the example of Fifth Generation (5G) wireless protocol. However, applicability of the disclosed techniques is not limited to only 5G wireless systems.

Headings are used below for clarity of presentation and are not intended to limit the applicability of the subject matter across the various disclosed embodiments.

For multi-subscriber identity module (multi-SIM) wireless devices, the wireless device may connect to multiple networks at the same time. This may need coordination of the wireless device capability (capability coordination). As used herein, a “wireless device” can be any kind of wireless device including a user equipment, a mobile station, smartphone, a tablet device, a laptop device, or any other wireless device. The foregoing terms are used interchangeably. The multi-SIM can include multiples of the SIM/USIM (Universal Mobile Telecommunications System Subscriber SIM), a soft SIM, an embedded SIM, or a virtual SIM. The virtual SIM has a subscription is download from the network.

A wireless device that is roaming may connect to multiple networks using different slices which also may require capability coordination.

Video, Imaging and Audio for Professional Applications (VIAPA) devices may require a wireless device to receive data services from one network (e.g., a non-public network (NPN)), and paging as well as data services from another network (e.g., a public land mobile network (PLMN) simultaneously which may also require wireless device capability coordination.

In some standards, a radio access capability signaling (RAGS) defined radio access capability as a predefined or network defined wireless device capability via an identifier.

Multi-SIM wireless devices may connect to multiple networks simultaneously in the following different cases:
1) Receiving a paging message via a second SIM (SIM2) when a first SIM (SIM1) is in connected state to a first network. This situation can be accommodated via time-division multiplexing (TDM). For example, by reserving a scheduling gap for SIM2 so that there is no simultaneous connection to two networks requiring coordination. For a wireless device with dual receivers, this scheme will affect the performance of SIM1 by reserving a scheduling gap with the paging period. Another solution for the dual receiver wireless device is to reserve part of the radio frequency/physical layer (RF/PHY) resources for receiving the paging message.
2) A short dual connected state or a dual control plan connected state, For example, if SIM1 is in a connected state, and SIM2 must make a mobility update such as with periodic registration, moving into a new registration area, or a response to paging. For these cases, the wireless device may need capability cooperation during the short dual connected state.
3) A long dual connected state or a dual user plan connected state. For example, the wireless device may have a voice call on SIM1 and another data service on SIM2. For this case, the wireless device may need capability cooperation.

As an enhancement on the slice, some systems may need to enable a roaming wireless device to access network slices from more than one visited public lane mobile network (VPLMN) simultaneously. As such, wireless devices may connect to two networks simultaneously which has similar challenges to the multi-SIM wireless device and may require wireless device capability cooperation.

VIAPA (Video, Imaging and Audio for Professional Applications) may require a wireless device to receive data services from one network (e.g. NPN), and paging as well as data services from another network (e.g. PLMN) simultaneously. Then the similar issues to the multi-SIM on the UE capability cooperation shall be discussed.

In the following description, solutions are described for a multi-SIM wireless device but can also apply to the roaming wireless device and VIAPA cases described above.

### Capability Coordination for Receiving a Paging Message

For a dual receiver wireless device, to receive a paging message using SIM2 when SIM1 is connected to a network, the wireless device can split part of the RF/PHY resources to detect paging on SIM2. There are two options:

Option A: The wireless device always reserves part of the RF/PHY resources for receiving the paging message. For this option, the wireless device reports the maximum capability of the wireless device excluding a reserved part during registration in a multi-SIM mode. The wireless device can report its maximum capability during registration in a single-SIM mode,

Option B: Reserve part of RF/PHY resource for the receiving the paging message only for a paging gap. The wireless device will send the gap position in time for checking the paging of SIM2 to the network of SIM1. For example, the wireless device may be using all of the PHY/RF resources for SIM1 for a high quality of service process when a SIM2 paging message occurs. To accommodate the gap needed by SIM2 for the pging message, the wireless device will inform SRC about a reduced wireless device capability and the SIM2 paging gap. Network A connected to SIM1 will take the reduced capability into consideration in allocating resources.

For the dual receiver wireless device, the wireless device can reserve part of RF/PHY resources for paging detection. Th reserved part can be a permanent reservation or can be reserved only for the required paging gap.

For both options, there are two wireless device capability sets (also referred to herein as a “capability set”):
1) A full wireless device capability set, which can be used in a single SIM mode for options A or B, or for the time duration outside of the paging gap for option B. The full capability set indicates the maximum capability of the wireless device. For example this may include per wireless device parameters, per band parameters, per band combination parameters, per band per band combination parameters, or per carrier component (CC) parameters.
2) A reduced wireless device capability set, which can be used in a multi-SIM mode for option A, or for the paging gap in option B. The reduced capability set are one or more of: per band combination parameters, per band per band combination parameters, or
the per CC parameters.

### Full Capability Sets and Reduced Capability Sets

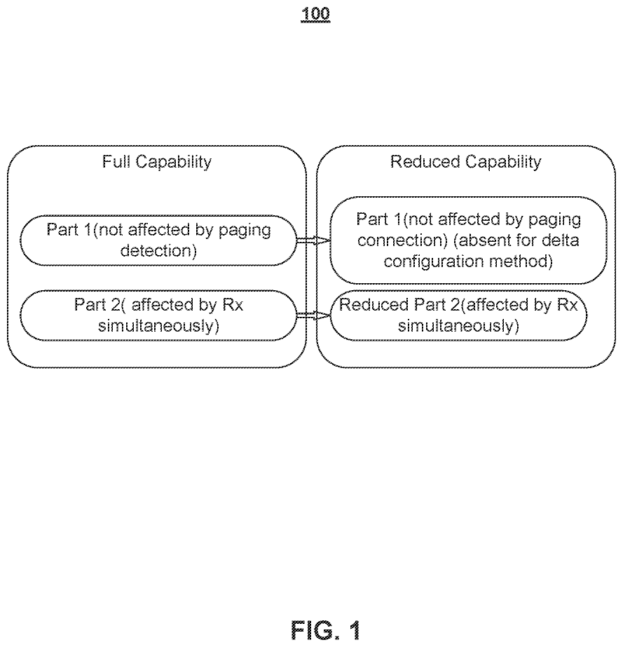

In some example embodiments, the wireless device sends or reports to the network multiple wireless device capability sets. For example, the wireless device may send a full wireless device capability set and reduced device capability set (the reduced device capability set is equal to the full device capability set minus the reserved RF/PHY resources for the paging detection), Multiple reduced capability sets can be sent, FIG. 1 depicts a schematic comparison of a fill capability set to a reduced capability set.

The wireless device should indicate to the network the correct wireless device capability for each particular time. For option A, considering that the wireless device will not change its working mode frequently, it can indicate the wireless device capability during registration based on the wireless device working mode (single SIM or multi-SIM), and when the wireless device capability changes, the UE can trigger the registration procedure. For option B, when the wireless device is operating in the multi-SIM mode, the wireless device can indicate two capability sets to the network using the following methods.

Solution 1: The wireless device can report two capability sets during the registration procedure. The capability sets can be via capability information or capability identifiers (IDs) as radio access capability signaling (RACS). A delta configuration which indicates changes between capability sets for the reduced capability sets can be adopted. The core network (CN) can indicate to the base station, (e.g., next generation node B (gNB)) both capability sets, and the base station can further determine which capability will be adopted based on the current timing.

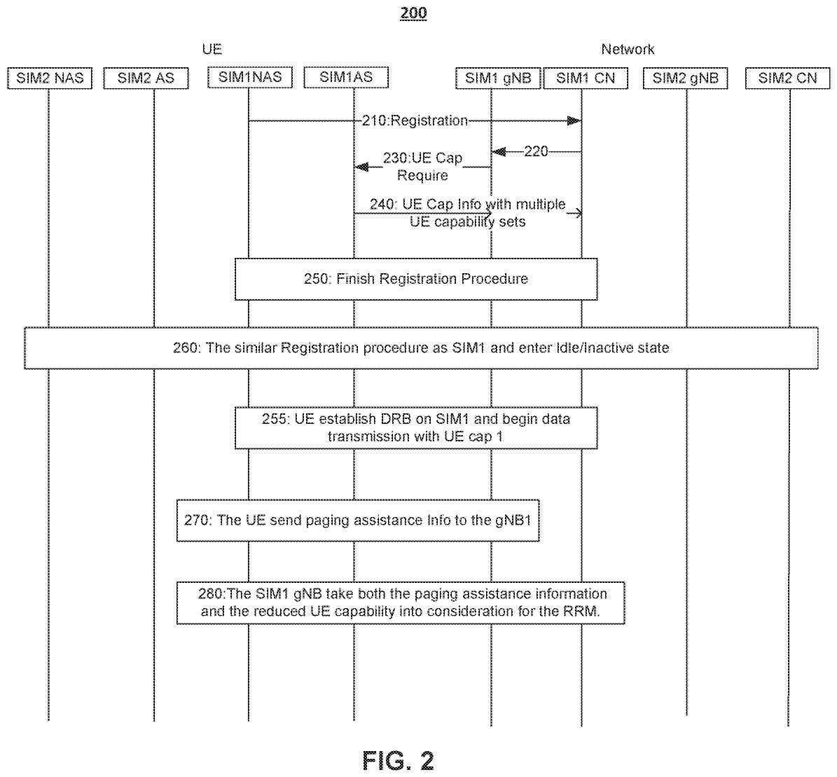

FIG. 2 depicts an example of a process for solution 1 above. At 210, the wireless device indicates a multi-SIM and/or dual radio in a non-access stratum (NAS) message (e.g. registration or radio resource control (RRC) message such as Msg5). At 220, the CN indicates to the base station to request the wireless device capability, the CN can also indicate the multi-SIM and/or dual radio state to the radio access network (RAN). At 330, the base station sends the wireless device capability required message to the access stratum (AS) and may require multiple capability sets. At 240, the wireless device sends multiple capability sets (e.g, wireless device capability set 1/2 as defined above in the wireless device capability information message including the full capability set and the reduced wireless device capability set for paging detection. Note: Considering the message size, the network can require this capability one by one, the wireless device can indicate it supports reduced capability in the first wireless device capability information, or RACS can include wireless device capability IDs in the registration and indicate which one is the reduced wireless device capability. At 250, the wireless device finishes the registration procedure on SIM1. At 260, the wireless device uses a similar procedure as the procedure for SIM1 to finish the registration at SIM2. At 255, the wireless device establishes a data radio bearer (DRB) on SIM1 and begins data transmission. At 270, the UE detects paging on SIM2 and sends assistance Information for the paging detection including one or more of the time domain information of the period paging detection gap, paging detection frequency, SCS/Bandwidth of the paging detection band . At 280, the SIMI base station takes both the paging assistance information and the reduced wireless device capability into consideration for the radio resource management (RRM).

Solution 2: The wireless device reports the full capability set during the registration procedure, and then reports the reduced capability by assistance information. It can send some parameters to restrict maximum values on some wireless device capability parameters such as maximums component carriers (CCs).

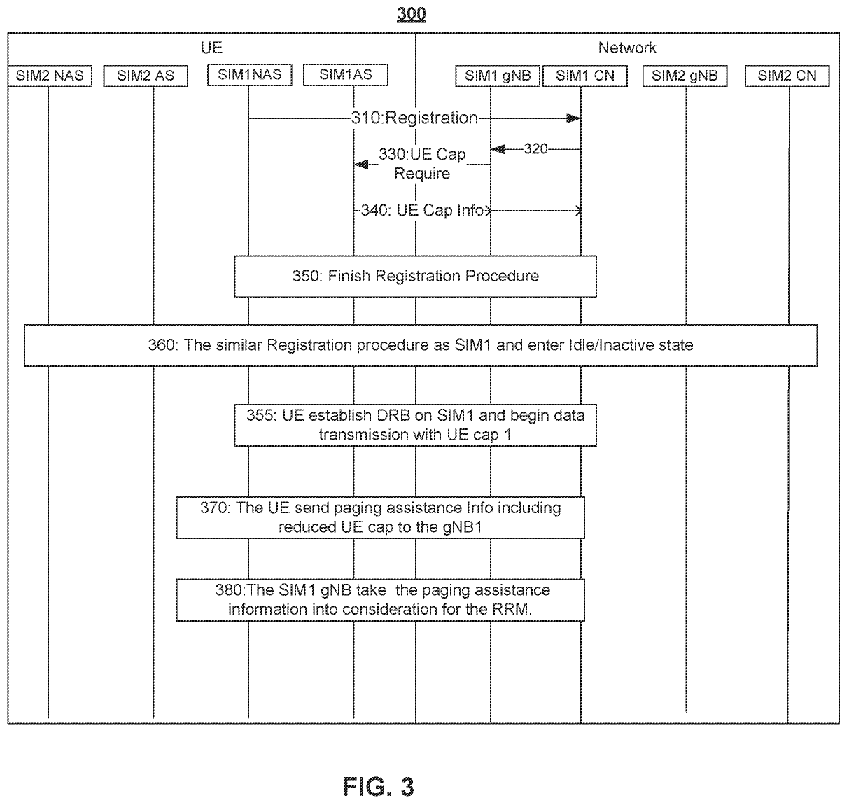

FIG. 3 depicts an example of a process for solution 2 above. At 310, 320, 330, 340, 350, and 360, the wireless device finishes the registration procedure on SIM1 and SIM2. At 355, the wireless device establishes DRB on SIM1 and begins data transmission. At 370, the wireless device detects the paging on the SIM2 and sends assistance Information for the paging detection including time domain information about the period paging detection gap and the reduced wireless device capability related information (a reduced value or a maximum value limitation). At 380, the SIM1 base station takes the paging assistance information into consideration for the RRM.

The reduced capability sets can be sent by capability information or by assistance information. In solution 1, the wireless device reports two wireless device capability sets during the registration procedure which can be wireless device capability information or wireless device capability IDs as RACS. A delta configuration for the reduced capability can be adopted. In solution, the wireless device reports the full capability set during the registration procedure, and then report the reduced capability by assistance information

Both the solution 1 and solution 2 can work for paging detection. Solution 2 is dynamic and may depend on how many capability parameters are impacted. The wireless device may re-send the assistance information once the wireless device is back to the connected state from the idle state. Solution 1 may be a semi-static scheme where the wireless device can report the reduced capability for the paging detection during the registration procedure, which will also be stored at the CN.

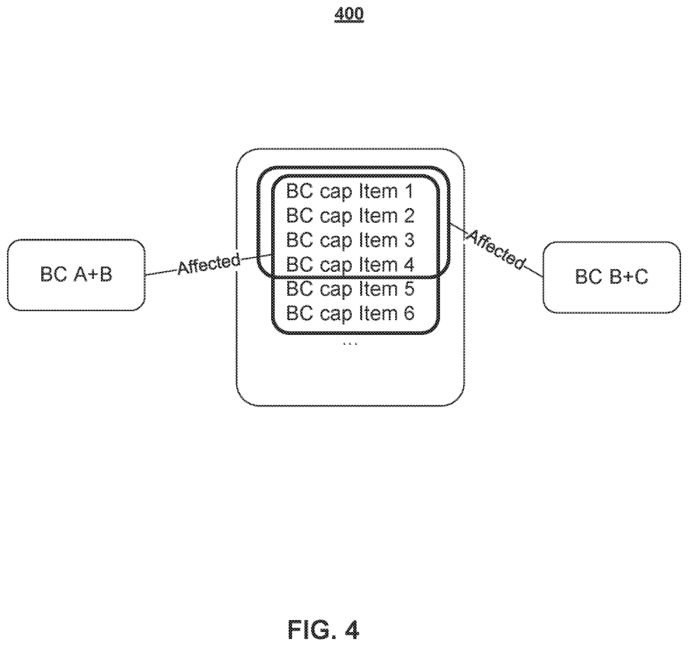

Determining whether to use solution 1 or solution 2 may depend on how many capability parameters are impacted. For the wireless device capability, the baseband and RF capabilities are mainly included in the band combination. If the wireless device needs to detect paging on a certain band, it may affect the capabilities for the band combinations that don't include this paging detection band. For the band combinations that include this paging detection band the capabilities that are affected should be determined. FIG. 4 shows six band combination capability items: BC cap item 1-6. FIG. 4 shows an example where the full capability set includes band combination (BC) BC1 (B+A) and BC2 (B+C), then if the wireless device on SIM2 uses band A, in the reduced capability set, for the BC1 (B+A), detecting paging on band A may affect the band combination capability item 1-6, while for the BC2 (B+C), it may only affect the band combination capability item 1-4.

### Affected Per-Band Combination Capability

The affected capability items are different for the BC with the paging detection band and without the paging detection band. If the affected capabilities are different, the paging detection band of SIM2 may be indicated to network A as paging assistance information and the network can further determine which BC capabilities are affected.

Adopted Capability with Solution 1

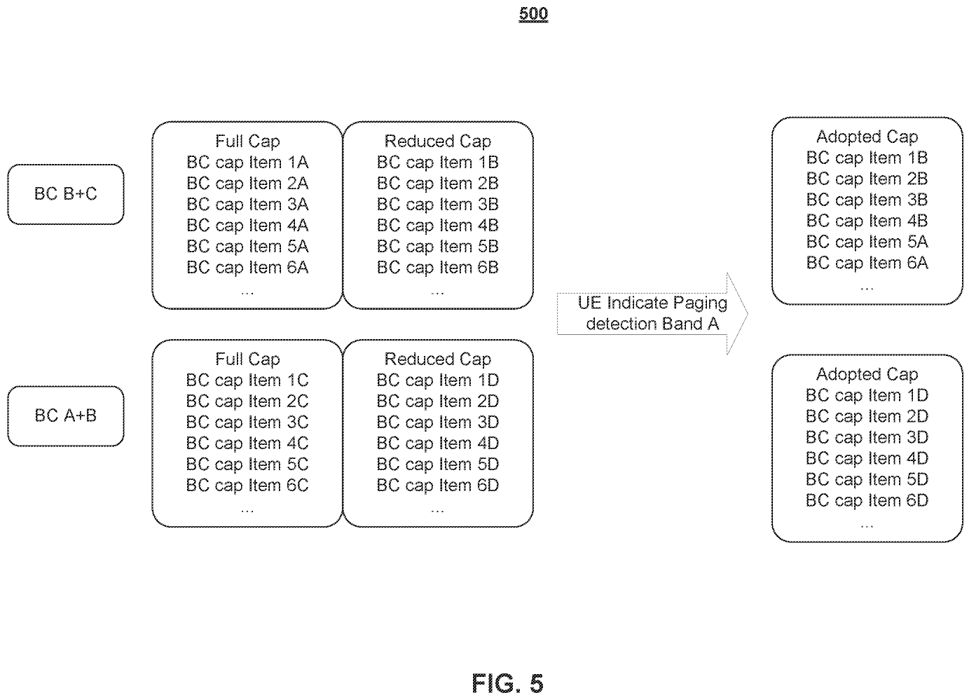

In the solution 1 example, the wireless device can include the reduced capability where the entire band is affected by the paging detection in a multi-SIM mode. Once the wireless device reports the dedicated paging detection band of SIM2, the BC capabilities that are not affected by the paging detection (e.g. BC capability (cap) item 5A/6A and 5D/6D in FIG. 5), the network can adopt the capability in the full capability set for the BC that does not include the paging detection band. For solution 1, the wireless device can include the reduced capability with the assumption that all of the band was affected by the paging detection band in multi-SIM mode, and network can determine the final capability by taking all of the full capability set/reduced capability set/paging detection band into consideration.

For solution 2, within the assistance Information, the UE may include maximum values for the affected capabilities e.g. BC capability items 1-6, then for the BC with the paging detection band, all of the maximum values shall be considered, but for the BC without the paging detection band, it may include just the maximum values for the BC capability items 1. 4, If the affected capabilities are different for the BC with and without the paging detection band, the paging detection band of the SIM2 is indicated to network 1. Then the network 1 can further determine which BC capabilities are affected. The paging detection band information also benefits the radio resource management of network 1. In addition to the per BC capability, there are also per UE capability and per band capability, for the per band capability, the same logic as per BC capability can be adopted.

### Capability Coordination for Dual Connected State

For paging detection on SIM2, only the receive capability on SIM1 may be affected, but for the dual connected state (SMI1 and SIM2), both the receive and transmit capabilities may be affected. Two scenarios are possible: a) dual receive and single transmit, and b) dual receive and dual transmit. For the dual receive and single transmit case, the wireless device transmits in a time-division multiplexing (TDM) mode on both networks. Accordingly, the requirement for capability coordination is mainly from the receive aspect, which is similar to paging detection. For dual receive and dual transmit case, the wireless device can transmit simultaneously. Accordingly, transmit cooperation is needed in addition to receive coordination. For transmit capability coordination, multiple wireless device capability sets may be needed.

### Multiple Wireless Device Capability Sets

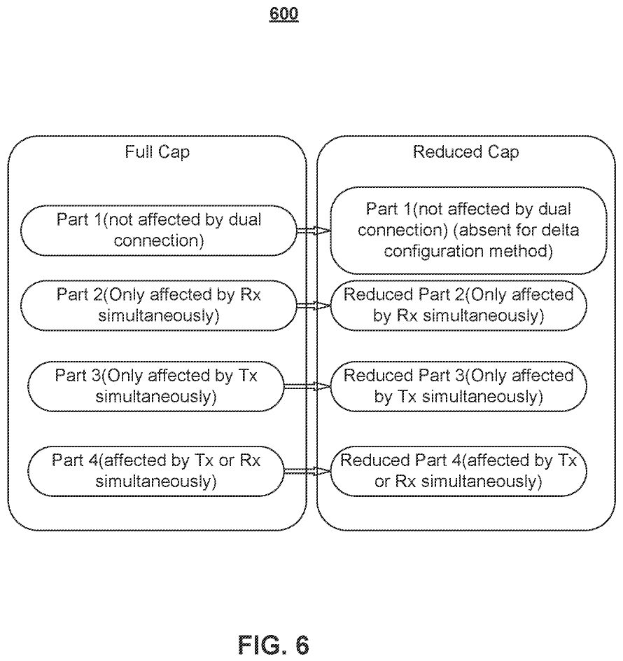

FIG. 6 shows an example of dividing wireless device capability into four categories:

Part 1: Capabilities that are not affected by dual connected state or paging detection on the other SIM card;

Part 2: Capabilities that are only affected when the wireless device needs to receive from two SIM cards simultaneously;

Part 3: Capabilities that are only affected when the wireless device needs to transmit from two cards simultaneously;

Part 4: Other capabilities that are affected by both simultaneous receive and simultaneous transmit.

For a wireless device with SIM1/SIM2, when the SIM2 is at idle/inactive state, for the paging occasion (PO) of SIM2, SIM1 can only use the reduced part 2/4 in the reduced capability. For the other parts (part 1/3), SIMI can use the capabilities identified in the full capability set. When SIM2 needs to enter the connected state, the wireless device will take the entire reduced capability into consideration. Multiple wireless device capability sets may be needed for the wireless device capability cooperation of a dual connected state. For example, a full UE capability set and a reduced UE capability set, where the reduced capability is adopted in the dual connected state mode.

Similar to capability coordination for paging detection, the following are also applicable in the dual connected state.

The reduced capability sets can be sent by wireless device capability information or by assistance information. Two solutions include:

Solution 1: wireless device reports multiple capability sets during the registration procedure. The multiple capability sets can be sent via capability information or identified in capability identifiers such as using RAGS. A delta configuration for the reduced capability can be adopted. For example, a delta configuration can indicate differences in capability.

Solution 2: wireless device reports the full capability set during the registration procedure, and then reports the reduced capability via assistance information.

The affected capability items may be different for the BC with and without the connected band of SIM2.

If the affected capabilities are different, the connected band of the SIM2 can also be indicated to the network 1, then the network 1 can further determine which BC capabilities are affected. Besides, the connected band information may also benefit the radio resource management of the network 1.

### Procedures for Solution 1

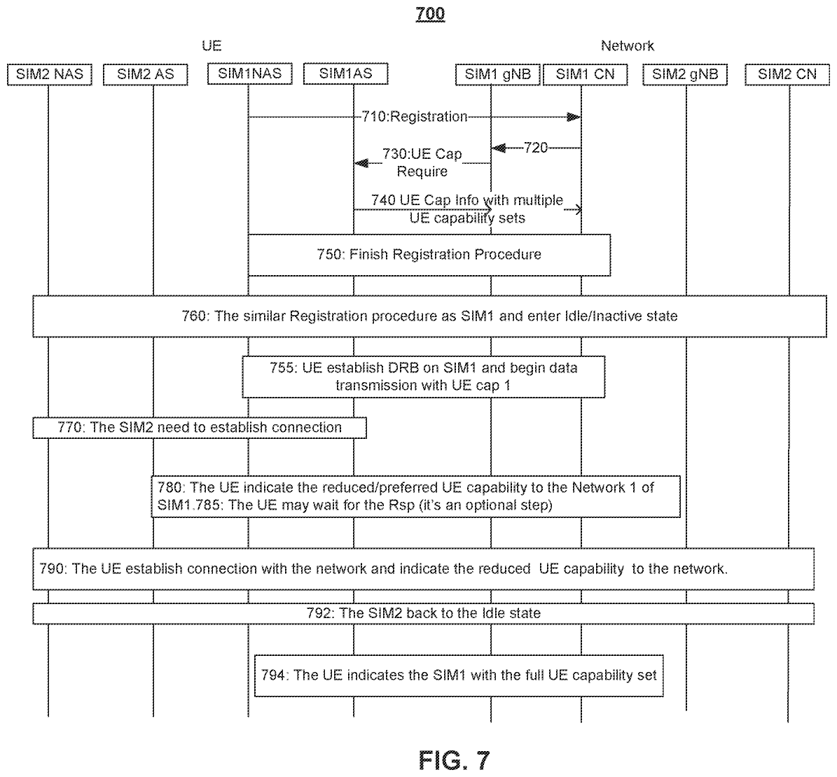

FIG. 7 shows an example procedure 700 based on solution 1 above.

At 710 the wireless device indicates the multi-SIM and/or dual radio state in a NAS message. For example, a registration or RRC message such as Msg5.

At 720, the core node indicates to the base station (e.g., gNB) to get the wireless device capability. The CN can also indicate the multi-SIM or dual radio state to the RAN.

At 730, the RAN sends the wireless device capability required message to the RAN. This message may indicate that multiple capability sets are required.

At 740, the wireless device sends multiple capability sets. For example, capability set 1/2 as described above in the capability information. Msg. 1 is the full capability set, 2 is the reduced capability set for the dual connected state. Considering the message size, the network can require this capability one by one, the UE can indicate it supports reduced capability in the first UE capability info. Or RAGS can include two wireless device capability identifiers in the registration and indicate which one is the reduced UE capability.

At 750, the wireless device finishes the registration procedure for SIM1. At 760, the wireless device uses a similar procedure to SIM1 to finish the registration procedure of SIM2 and enters the inactive/idle state.

At 755, the wireless device establishes DRB on SIM1 and begins data transmission using wireless device capability 1.

At 770, the wireless device establishes a connection on SIM2 and does capability negotiation internally with SIM1.

At 780, the wireless device adopts the reduced capability set on network 1 of SIM1.

At 785, the wireless device may wait for the response.

At 790, the UE establishes connection with the network and indicates the reduced capability to the network.

At 792, SIM2 enters the idle/inactive state.

At 794, the wireless device indicates the network 1 return to the full capability set.

### Multiple Reduced Capability Sets

In the above example, only one reduced capability set is used, but as mentioned above, there are two dual connected state types:

Type 1: Short dual connected state. For example, SIM1 is in the connected state, and SIM2 must do a mobility update, (e.g. periodic registration, moving into a new registration area, or response to the paging). In this case, the wireless device will need capability cooperation during the short dual connected state.

Type 2: Long dual connected state: For example, the wireless device may have a voice call on SIMI and may have some other data service on SIM2. In this case, the wireless device may need capability cooperation.

Generally, the Type 1 can be considered to be a control plane dual connected state, while the second type can be considered to be a user plane dual connected state. For different dual connected state types, the different capability maybe adopted.

For the short dual connected state with only the control plane using SIM2, reduced capability set 1 can be adopted, while for the dual connected state with data transmission, SIM2 may need to occupy more RF/Phy resources, then the reduced capability set 2 can be adopted. The wireless device needs to indicate to the network which capability set is preferred based on the services of the two SIMS.

For the solution 2, to indicate to the network which capability set is preferred, the wireless device can indicate the reduced capability directly. For the solution 1, the wireless device may give the preferred capability identifier (if RAGS adopted, for this solution it will also affect the SA and RAN 3) or a reduced capability set index.

Solution 1 is semi-static and can be stored at the CN, while the solution 2 is dynamic and will be released in the idle state. These two schemes can also be combined for the different scenarios and requirements. For example, when the wireless device enters a dual user plane (UP) connection, the network can take the reduced capability set 2 as a baseline, and then the wireless device can send further assistance information to limit the maximum number based on the reduce capability set 2.

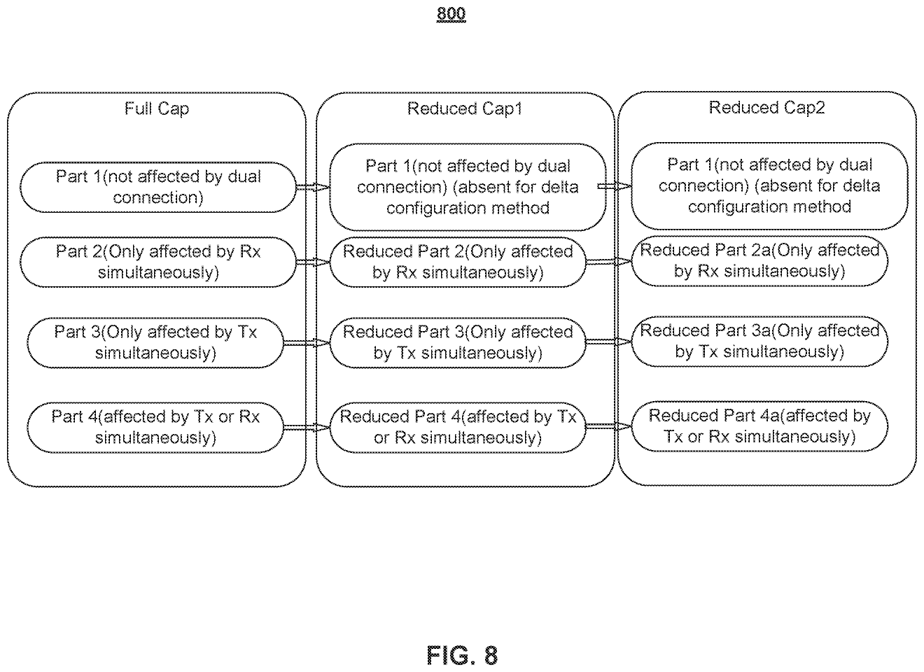

FIG. 8 depicts examples of a full capability set and multiple reduced capability sets.

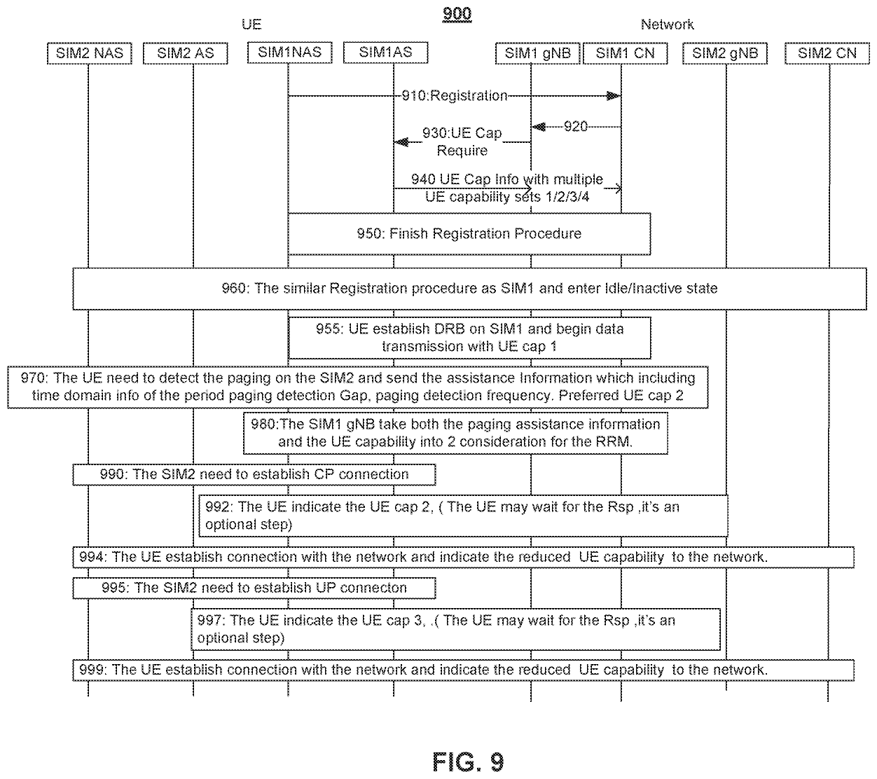

For better understanding the multiple wireless device capability schemes, a typical procedure for solution 1 is described below in FIG. 9. In this example, the wireless device reports four reduced capability sets:

Capability Set 1: Full capability set

Capability Set 2: Reduced capability set for the paging detection

Capability Set 3: Reduced capability for control plane (CP) dual connected state

Capability Set 4: Reduced capability for the UP dual connected state. Note: Capability set 2 can be part of capability set 3.

In FIG. 9, at 910, the wireless device indicates the multi-SIM and/or dual radio mode in a NAS message (e.g., registration or RRC message (e.g., Msg5).

At 920, The CN indicates to the base station (e.g., gNB) to get the wireless device capability. Thee CN can also indicate the multi-SIM or dual radio state to the RAN.

At 930, the RAN sends the wireless device capability required message to the RAN. This message may require multiple capability sets.

At 940, the wireless device sends multiple wireless device capability sets such as wireless device capability sets 1/2/3/4 as defined above in the wireless device capability information message. Capability set 1 is the full wireless device capability set, 2/3/4 are the reduced wireless device capability sets for the dual connected state. Considering the message size, the network can require capability sets one by one, the wireless device can indicate it supports reduced capability in the first wireless device capability information, or RACS can be used to include 4 wireless device capability identifiers in the registration message and indicate which is the reduced capability set.

At 950, the wireless device finishes the registration procedure on SIM1.

At 960, the wireless device uses a similar procedure to SIMI to finish the registration procedure for SIM2.

At 970, the wireless device detects the paging on SIM2 and sends assistance Information for the paging detection which includes time domain info for the period paging detection gap, paging detection frequency, and/or a preferred wireless device capability set.

At 980, the SIMI base station (e.g., gNB) takes both the paging assistance information and the reduced capability into consideration for the RRM.

At 990, the wireless device establishes a control plane connection to SIM2 and may internally perform capability negotiation with SIM1.

At 992, the wireless device indicates adoption of a reduced capability set to network 1 of SIM1. The wireless device may wait for a response.

At 994, the wireless device establishes a dual control plane connection with network 2 and indicates the reduced capability set.

At 995, the wireless device establishes an UP connection on SIM2 and may internally perform wireless device capability negotiation with SIM1.

At 997, the wireless device indicates to adopt the reduced wireless device capability 4 to the Network 1 of SIMI, The wireless device may wait for a response.

At 999, the wireless device establishes dual UP connection with the network 2 and indicates the reduced capability.

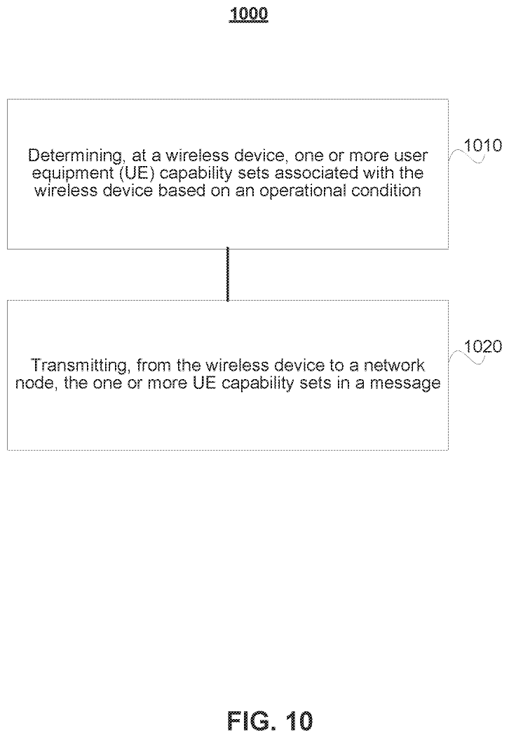

FIG. 10 shows an example of a method 1000 for wireless communication. At 1010, in some embodiments of the disclosed technology, the method includes determining, at a wireless device, one or more user equipment (UE) capability sets associated with the wireless device based on an operational condition. At 1020, the method includes transmitting, from the wireless device to a network node, the one or more UE capability sets in a message.

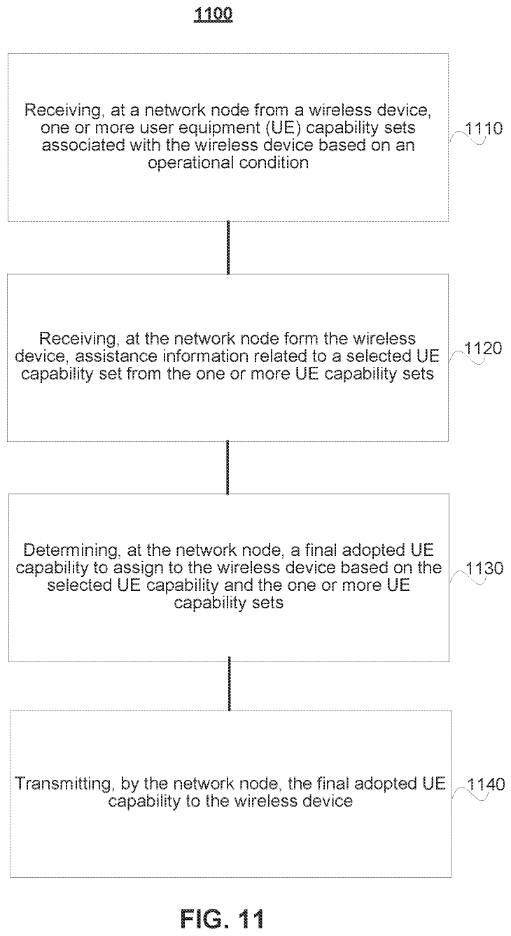

FIG. 11 shows another example of a method 1100 for wireless communication. At 1110, in some embodiments of the disclosed technology, the method includes receiving, at a network node from a wireless device, one or more user equipment (UE) capability sets associated with the wireless device based on an operational condition. At 1120, the method includes receiving, at the network node form the wireless device, assistance information related to a selected UE capability set from the one or more UE capability sets. At 1130, the method includes determining, at the network node, a final adopted UE capability to assign to the wireless device based on the selected UE capability and the one or more UE capability sets. At 1140, the method includes transmitting, by the network node, the final adopted UE capability to the wireless device.

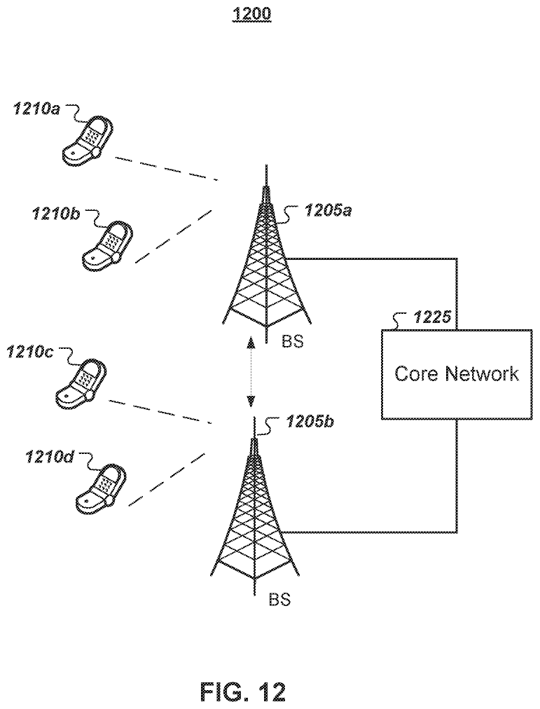

FIG. 12 shows an example of a wireless communication system 1200 where techniques in accordance with one or more embodiments of the present technology can be applied. A wireless communication system 1200 can include one or more base stations (BSs) 1205a, 1205b, one or more wireless devices 1210a, 1210b, 1210c, 1210d, and a core network 1225. A base station 1205a, 1205b can provide wireless service to wireless devices 1210a, 1210b, 1210c and 1210d in one or more wireless sectors. In some implementations, a base station 1205a, 1205b includes directional antennas to produce two or more directional beams to provide wireless coverage in different sectors. The base station 1205a, 1205b may communicate directly with one another wirelessly or via a wired interface including a direct wired interface, a wired network, or the Internet.

The core network 1225 can communicate with one or more base stations 1205a, 1205b. The core network 1225 provides connectivity with other wireless communication systems and wired communication systems. The core network may include one or more service subscription databases to store information related to the subscribed wireless devices 1210a, 1210b, 1210c, and 1210d. A first base station 1205a can provide wireless service based on a first radio access technology, whereas a second base station 1205b can provide wireless service based on a second radio access technology, The base stations 1205a and 1205b may be co-located or may be separately installed in the field according to the deployment scenario. The wireless devices 1210a, 1210b, 1210c, and 1210d can support multiple different radio access technologies. The techniques and embodiments described in the present document may be implemented by the base stations described in the present document or by wireless devices.

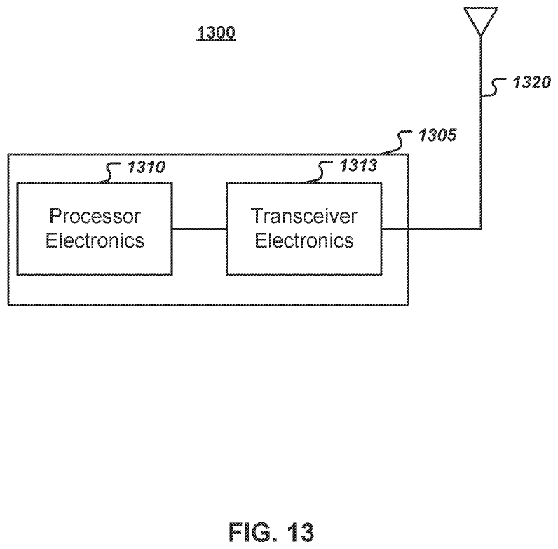

FIG. 13 is a block diagram representation of a portion of a wireless device or base station in accordance with one or more embodiments of the present technology can be applied. A radio 1305 such as a base station or a wireless device (or UE) can include electronics 1310 such as a microprocessor that implements one or more of the wireless techniques presented in this document. The radio 1305 can include transceiver electronics 1313 to send and/or receive wireless signals over one or more communication interfaces such as antenna 1320. The radio 1305 can include other communication interfaces for transmitting and receiving data, Radio 1305 can include one or more memories (not explicitly shown) configured to store information such as data and/or instructions. In some implementations, the processor electronics 1310 can include at least a portion of the transceiver electronics 1315. In some embodiments, at least some of the disclosed techniques, modules or functions are implemented using the radio 1305, In some embodiments, the radio 1305 may be configured to perform the methods described in this document.

### UE Capability Reporting

The UE can report a single carrier capability that is outside of the network requested band lists. The UE sends a UE capability enquiry message (UECapabilityEnquiry) to the network and the network replies with UE capability information (UECapabilityInformation).

The UE capability enquiry message includes a frequencyBandListFilter parameter. In a UE capabilityInformation message, only the BC capabilities (including single CC capability) for the bands that were included in the frequencyBandListFilter are included. This leads to the UE being unable to report the single CC capability for the bands that are supported by UE but not included in the frequencyBandListFilter. Conventionally this triggers some problems. The issues relate to whether the network can handover to a supported band without any BC capabilities (including single CC capability). Without single CC capabilities, the network cannot determine the actions on the bands that are included in the not included in frequencyBandListFilter, For handover, if the network tries to handover to a band that is supported by the UE but without any BC capabilities, the network has to acquire the related capability first, which may increase the handover delay. Unless the network put all of the potential target bands into the frequencyBandListFilter in the preceding UE capability procedure, it will increase the signaling overhead significantly. To solve this problem, the UE can report the single CC capability for each supported band, which is not affected by the frequencyBandListFilter. For the CAIDC capability, the bands are included in the frequencyBandListFilter.

### Summary of Features

The following list summarizes some aspects of various embodiments.

The wireless device reports multiple capability sets to the network, e.g. full capability set and one or more reduced capability sets

The full capability set is the maximum capability when the wireless device is connected to one network.

The reduced capability sets are used when the wireless device is connected to more than one network. The wireless device can report more than one reduced UE capability sets.

The reduced capability sets can be sent via capability information or by assistance information.

The wireless device can report the multiple UE capability sets during a registration procedure. The capability sets can be sent via capability information or capability identifiers using FACS. A delta configuration indicating differences in capability between capability sets can be adopted.

The wireless device can report the full capability set during a registration procedure, and then report the reduced capability by assistance information

The above solutions can be combined for the different dual connected state scenarios and requirements,

The connected band/paging detection band of another network can be indicated to network 1, then the network 1 can further determine which BC capabilities are affected.

The network can determine the final capability by taking all of the full capability set and reduced capability set/paging detection band into consideration.

For paging detection, besides the paging detection band, the wireless device also sends the assistance information for the paging detection, which can include time domain information of the period paging detection gap.

The wireless device can indicate to the network which capability set is preferred based on the services of different networks dynamically.

The technical solutions described by the following clauses may be preferably implemented by some embodiments.

Clause 1. A method of wireless communication, comprising: determining, at a wireless device, one or more user equipment (UE) capability sets associated with the wireless device based on an operational condition; and transmitting, from the wireless device to a network node, the one or more UE capability sets in a message,

Clause 2. The method of wireless communication of clause 1, wherein the operational condition indicates that the wireless device is connected to one network, and wherein the one or more UE capability sets includes a full capability set.

Clause 3. The method of wireless communication of clause 1, wherein the operational condition indicates that the wireless device communicating with more than one network, and wherein the one or more UE capability sets include one or more reduced capability sets.

Clause 4. The method of wireless communication of clause 3, wherein the one or more reduced capability sets indicate less capability than a full capability set of the wireless device.

Clause 5. The method of wireless communication of clause 1, wherein the wireless device communicates with a first network using a first subscriber identity module and communicates with a second network using a second subscriber identity module.

Clause 6. The method of wireless communication of clause 1, wherein the wireless device connects to a first network via a first network slice and connects to a second network via a second network slice.

Clause 7. The method of wireless communication of clause 5, wherein the wireless device connects to the first network for first data or voice services and connects to the second network for paging and second data services.

Clause 8. The method of wireless communication of clause 1, wherein the one or more capability sets includes a full capability set and a reduced capability set, wherein the full capability set corresponds to a maximum capability of the wireless device connected to one network, wherein the reduced capability set corresponds to less than the maximum capability of the wireless device, and wherein the one or more UE capability sets include one or more of: a service data adaptation protocol (SDAP) capability, a packet data convergence protocol (PDCP) capability, a radio link control (RLC) capability, a medium access control (MAC) capability, a radio frequency (RF) capability, or a physical layer (PHY) capability.

Clause 9. The method of wireless communication of clause 4, wherein the first network is a non-public network (NPN) and the second network is a public land mobile network (PLMN),

Clause 10. The method of wireless communication of clause 1, wherein the one or more UE capability sets are transmitted during a registration procedure of the wireless device.

Clause 11. The method of wireless communication of clause 10, wherein the one or more UE capability sets are identified via capability identifiers or via radio access capability signaling (RACS),

Clause 12. The method of wireless communication of clause 11, further comprising: transmitting a full capability set from the one or more UE capability sets during a registration of the wireless device; and transmitting a reduced capability set via wireless device assistance information.

Clause 13. The method of wireless communication of clause 2, wherein the one or more UE capability sets comprise one or more of: per wireless device parameters, per band parameters, per band combination parameters, per band per band combination parameters, or per carrier component (CC) parameters.

Clause 14. The method of wireless communication of clause 3, wherein parameter values for the one or more reduced capability sets are determined assuming that all bands in a band combination are affected by another network.

Clause 15. The method of wireless communication of clause 1, further comprising: detecting, at the wireless device from a first network node, a paging message; determining an indication of resources assigned to the first network node, or information about a current working band or time domain information of a first network associated with the first network node; and transmitting, from the wireless device to a second network node, the indication of resources or information about the current working band or the time domain information.

Clause 16. The method of wireless communication of clause 1, further comprising: connecting, by the wireless device, to a first network node; determining an indication of resources assigned to the first network node, or information about a current working band or time domain information of a first network associated with the first network node; and transmitting, from the wireless device to a second network node, the indication of resources or information about the current working band or the time domain information,

Clause 17. The method of wireless communication of clauses 15 or 16, wherein the indication of resources assigned includes time domain information or frequency domain information.

Clause 18. The method of wireless communication of clauses 15 or 16, wherein the indication of resources assigned includes one or more current working bands, a subcarrier spacing (SCS), a SCS or bandwidth information of a working band.

Clause 19. The method of wireless communication of clauses 15 or 16, wherein the indication of resources indicates a paging detection band, an SCS, a bandwidth of a paging detection band of the wireless device, or time domain information of a paging detection.

Clause 20. The method of wireless communication of clauses 15 or 16, wherein the second network node determines a final capability to assign to the wireless device based on a full capability set, one or more reduced capability sets, resources assigned to the first network node, and information related to one or more current working bands of the first network.

Clause 21. The method of wireless communication of clauses 15 or 16, wherein the second network node determines wireless device capabilities and communications resources including a band combination affected by the communications resources assigned to the second network node.

Clause 22. The method of wireless communication of clause 1, further comprising: determining, by the wireless device, a preferred capability set from the one or more UE capability sets; and transmitting, from the wireless device to the network node, an indication of the preferred capability set.

Clause 23. The method of wireless communication of clause 22, wherein the preferred capability set is based on ongoing services of the wireless device.

Clause 24. A method of wireless communication, comprising: receiving, at a network node from a wireless device, one or more user equipment (UE) capability sets associated with the wireless device based on an operational condition; receiving, at the network node form the wireless device, assistance information related to a selected UE capability set from the one or more UE capability sets; determining, at the network node, a final adopted UE capability to assign to the wireless device based on the selected UE capability and the one or more UE capability sets; and transmitting, by the network node, the final adopted UE capability to the wireless device.

Clause 25. The method of wireless communication of clause 24, wherein the operational condition indicates that the wireless device is connected to one network, and wherein the one or more UE capability sets includes a full capability set.

Clause 26. The method of wireless communication of clause 24, wherein the one or more UE capability sets including a reduced capability set via wireless device capability information or wireless device assistance information, and wherein the reduced capability set indicates fewer capabilities than a full capability set of the wireless device.

Clause 27. The method of wireless communication of clause 26 wherein the one or more UE capability sets include a full capability set of the wireless device.

Clause 28. The method of wireless communication of clause 26, wherein the reduced capability set is sent via wireless device assistance information.

Clause 29. The method of wireless communication of clause 26, wherein the full capability set corresponds to a maximum capability of the wireless device connected to only one network and the reduced capability set corresponds to less than the maximum capability of the wireless device connected to more than one network, and wherein the maximum capability corresponds to a maximum wireless device capability, and wherein the full capability set and the reduced capability set include one or more of: a service data adaptation protocol (SDAP) capability, a packet data convergence protocol (PDCP) capability, a radio link control (RLC) capability, a medium access control (MAC) capability, a radio frequency (RF) capability, or a physical layer (PHY) capability.

Clause 30. The method of wireless communication of clause 24, further comprising: receiving, at the network node from the wireless device, an indication of resources assigned to a first network node or information about a current working band or time domain information of the first network; and determining, at the network node, a final adopted UE capability to assign to the wireless device.

Clause 31. The method of wireless communication of clause 30, wherein the second network node determines a final capability to assign to the wireless device based on a full capability set, one or more reduced capability sets, resources assigned to the first network node, and information related to one or more current working bands of the first network.

Clause 32. The method of wireless communication of clause 24, further comprising: receiving, at the network node from the wireless device, an indication of a preferred capability set from the one or more UE capability sets; and determining, by the network node, a final adopted capability to assign to the wireless device based on the one or more UE capability sets and the indication of the preferred capability set.

Clause 33. The method of wireless communication of clause 32, wherein a preferred capability set is based on ongoing services of the wireless device.

Clause 34. The method of wireless communication of clause 32, wherein the one or more UE capability sets includes a full capability set and a reduced capability set, wherein the full capability set corresponds to a maximum capability of the wireless device connected to only one network and the reduced capability set corresponds to less than the maximum capability of the wireless device connected to more than one network, wherein the maximum capability corresponds a maximum wireless device capability, and wherein the one or more UE capability sets one or more of: a service data adaptation protocol (SCRAP) capability, a packet data convergence protocol (PDCP) capability, a radio link control (RLC) capability, a medium access control (MAC) capability, a radio frequency (RF) capability, or a physical layer (PHY) capability.

Clause 35. The method of wireless communication of clause 32, wherein the one or more UE capability sets comprise one or more of: per wireless device parameters, per band parameters, per band combination parameters, per band per band combination parameters, or per carrier component (CC) parameters.

Clause 36. The method of wireless communication of clause 32, wherein parameter values for the reduced capability set are determined assuming that all bands in a band combination are affected by another network.

It will be appreciated that the present document discloses techniques that can be embodied in various embodiments to coordinate capabilities of a wireless device in a cellular network. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output, The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data, Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e,g,, internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format, The following clauses are supported and further described in the Examples above and throughout this document. As used in the clauses below and in the claims, a wireless terminal may be user equipment, mobile station, or any other wireless terminal including fixed nodes such as base stations. A network node includes a base station including a next generation Node B (gNB), enhanced Node B (eNB), or any other device that performs as a base station. A resource range may refer to a range of time-frequency resources or blocks.

1. A method of wireless communication, comprising:
determining, at a wireless device, one or more user equipment (UE) capability sets associated with the wireless device based on an operational condition; and
transmitting, from the wireless device to a network node, the one or more UE capability sets in a message.

2. The method of wireless communication of claim 1, wherein the operational condition indicates that the wireless device is connected to one network, and wherein the one or more UE capability sets includes a full capability set.

3. The method of wireless communication of claim 1, wherein the operational condition indicates that the wireless device communicating with more than one network, and wherein the one or more UE capability sets include one or more reduced capability sets.

4. The method of wireless communication of claim 3, wherein the one or more reduced capability sets indicate less capability than a full capability set of the wireless device.

5. The method of wireless communication of claim 1, wherein the wireless device communicates with a first network using a first subscriber identity module and communicates with a second network using a second subscriber identity module.

6. The method of wireless communication of claim 1, wherein the wireless device connects to a first network via a first network slice and connects to a second network via a second network slice.

7. The method of wireless communication of claim 5, wherein the wireless device connects to the first network for first data or voice services and connects to the second network for paging and second data services.

8. The method of wireless communication of claim 1, wherein the one or more capability sets includes a full capability set and a reduced capability set, wherein the full capability set corresponds to a maximum capability of the wireless device connected to one network, wherein the reduced capability set corresponds to less than the maximum capability of the wireless device, and wherein the one or more UE capability sets include one or more of: a service data adaptation protocol (SDAP) capability, a packet data convergence protocol (PDCP) capability, a radio link control (RLC) capability, a medium access control (MAC) capability, a radio frequency (RF) capability, or a physical layer (PHY) capability.

9. The method of wireless communication of claim 4, wherein the first network is a non-public network (NPN) and the second network is a public land mobile network (PLMN).

10. The method of wireless communication of claim 1, wherein the one or more UE capability sets are transmitted during a registration procedure of the wireless device.

11. The method of wireless communication of claim 10, wherein the one or more UE capability sets are identified via capability identifiers or via radio access capability signaling (RACS).

12. The method of wireless communication of claim 11, further comprising:
transmitting a full capability set from the one or more UE capability sets during a registration of the wireless device; and
transmitting a reduced capability set via wireless device assistance information.

13. The method of wireless communication of claim 2, wherein the one or more UE capability sets comprise one or more of:
per wireless device parameters,
per band parameters,
per band combination parameters,
per band per band combination parameters, or
per carrier component (CC) parameters.

14. The method of wireless communication of claim 3, wherein parameter values for the one or more reduced capability sets are determined assuming that all bands in a band combination are affected by another network.

15. The method of wireless communication of claim 1, further comprising:
detecting, at the wireless device from a first network node, a paging message;
determining an indication of resources assigned to the first network node, or information about a current working band or time domain information of a first network associated with the first network node; and
transmitting, from the wireless device to a second network node, the indication of resources or information about the current working band or the time domain information.

16. The method of wireless communication of claim 1, further comprising:
connecting, by the wireless device, to a first network node;
determining an indication of resources assigned to the first network node, or information about a current working band or time domain information of a first network associated with the first network node; and
transmitting, from the wireless device to a second network node, the indication of resources or information about the current working band or the time domain information.

17. (canceled)

18. (canceled)

19. (canceled)

20. (canceled)

21. (canceled)

22. The method of wireless communication of claim 1, further comprising:
determining, by the wireless device, a preferred capability set from the one or more UE capability sets; and
transmitting, from the wireless device to the network node, an indication of the preferred capability set.

23. The method of wireless communication of claim 22, wherein the preferred capability set is based on ongoing services of the wireless device.

24. A method of wireless communication, comprising:
receiving, at a network node from a wireless device, one or more user equipment (UE) capability sets associated with the wireless device based on an operational condition;
receiving, at the network node form the wireless device, assistance information related to a selected UE capability set from the one or more UE capability sets;
determining, at the network node, a final adopted UE capability to assign to the wireless device based on the selected UE capability and the one or more UE capability sets; and
transmitting, by the network node, the final adopted UE capability to the wireless device.

25. (canceled)

26. The method of wireless communication of claim 24, wherein the one or more UE capability sets including a reduced capability set via wireless device capability information or wireless device assistance information, and wherein the reduced capability set indicates fewer capabilities than a full capability set of the wireless device.

27. (canceled)

28. (canceled)

29. (canceled)

30. (canceled)

31. (canceled)

32. (canceled)

33. (canceled)

34. (canceled)

35. (canceled)

36. (canceled)
